(19) United States
(12) Patent Application Publication
(10) Pub. No.: US 2006/0200362 A1
(43) Pub. Date: Sep. 7, 2006

(54) Presentation instrument insert systems and methods

(75) Inventors: Edward D. Paciolla, Canton, GA (US); Paul Matthew Fortney, Omaha, NE (US); Stephen Jay Hug, Omaha, NE (US); Glen David Wordekemper, Omaha, NE (US); Ronald L. Prchal, Plattsmouth, NE (US); Timothy James Horton, Papillion, NE (US); Martin G. Stivers, Glenwood, IA (US); Larry A. Martinez, Elkhorn, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/357,717

(22) Filed: Feb. 16, 2006

Related U.S. Application Data
(63) Continuation-in-part of application No. 10/959,637, filed on Oct. 5, 2004.
(63) Continuation-in-part of application No. 10/855,867, filed on May 26, 2004.

(51) Int. Cl. G06Q 99/00

(52) U.S. Cl. 705/1

(57) ABSTRACT

A method of providing a postcard presentation instrument for use in a transaction includes applying an information storage medium to a postcard to create a postcard presentation instrument, delivering the postcard presentation instrument to a destination via a distribution system, and settling a transaction involving the postcard presentation instrument. A system for providing a postcard presentation instrument for use in a transaction includes a processing system for applying an information storage medium to a postcard to create a postcard presentation instrument, and a host computer system that receives a request to activate the postcard presentation instrument.

### CROSS-REFERENCES TO RELATED APPLICATIONS

This application is a continuation-in-part of U.S. patent application Ser. No. 10/959,637 filed Oct. 5, 2004 (Attorney Docket No. 020375-058100US), and is a continuation-in-part of U.S. patent application Ser. No. 10/855,867 filed May 26, 2004 (Attorney Docket No. 020375-049900US), the entire disclosures of which are herein incorporated by reference for all purposes.

### BACKGROUND OF THE INVENTION

The present invention generally relates to presentation instruments. More specifically, the present invention relates to methods and systems for including presentation instruments such as gift cards and other non-activated stored value cards in distribution materials such as postcards and magazines.

Stored value cards, such as gift cards, pre-paid metered accounts, and the like, are well-known for providing access to goods and services. For example, stored value, or gift cards, may be purchased from various merchants such as Target®, Wal-Mart®, Starbucks®, Sears®, Blockbuster®, Macy's®, Banana Republic®, and the like. The purchase and usage of financial presentation instruments has continued to increase in recent years to the point that the sale of stored value cards today is a multi-billion dollar industry.

Given this rise in popularity, alternative distribution methods are needed. Unfortunately, however, stored value cards are nearly equivalent to cash, and in some circumstances postal distribution can be risky. Thus, systems and methods are needed that enable safe distribution of stored value cards and other presentation instruments.

Further, it would be advantageous to be able to target market presentation instruments. It may make little sense to send a stored value card good for a specific retailer to a consumer who never patronizes that retailer. Thus, systems and methods are needed to more effectively target market stored value cards and other presentation instruments. Moreover, there continues to be a need for presentation instruments that can be used inexpensively and in mass quantity. There also continues to be a need for increasing the number of active presentation instruments in the market, and a need for more marketing opportunities for merchants and other businesses. There is also a need for additional distribution methods for presentation instruments, and for presentation instruments that provide expanded space for writing and graphics. The present invention provides solutions for at least some of these needs.

### BRIEF SUMMARY OF THE INVENTION

Systems and methods are provided to more effectively target market stored value cards and other presentation instruments. Moreover, such presentation instruments can be implemented inexpensively and in mass quantity. Thus, it is possible to increase the number of active presentation instruments in the market, and provide more marketing opportunities for merchants and other businesses. Improved distribution methods for presentation instruments are also provided.

In a first aspect, embodiments of the present invention provide a method of providing a postcard presentation instrument for use in a transaction. The method can include applying an information storage medium to a postcard to create a postcard presentation instrument, delivering the postcard presentation instrument to a destination via a distribution system, and settling a transaction involving the postcard presentation instrument. The postcard presentation instrument may be matched with a primary component. Relatedly, the primary component may be a magazine, a circular, a book, a newspaper, a value pack mailer, a periodical, a newsletter, a journal, or a mass mailer. In some embodiments, the postcard presentation instrument can be configured as a fold-over postcard presentation instrument. In some embodiments, the postcard presentation instrument can be placed between two pages of a magazine. Relatedly, the postcard presentation instrument can be affixed with a page of a magazine. In some embodiments, the postcard presentation instrument can be inserted into a value pack mailer.

In another aspect, embodiments include a method of providing a presentation instrument for use in a transaction, where the method includes matching the presentation instrument with a primary component, delivering the matched presentation instrument and primary component to a destination via a distribution system, and settling a transaction involving the presentation instrument. In some embodiments, the primary component includes a postcard, and the presentation instrument is attached with the postcard via a perforation. The postcard can be configured as a fold-over postcard. Relatedly, the primary component may be a magazine, and the presentation instrument can be placed between two pages of the magazine. In some instances, the distribution system can include a public postal system, a private postal system, a courier service, or any combination thereof. In some embodiments, the destination can be a newsstand location, a retail outlet location, a transportation system location, a sidewalk location, a post office box, a residential mailbox, a personal residence address, or a business address. In some instances, the presentation instrument can include a paper card stock material.

In another aspect, embodiments include a system for providing a postcard presentation instrument for use in a transaction. The system may include a processing system for applying an information storage medium to a postcard to create a postcard presentation instrument, and a host computer system that receives a request to activate the postcard presentation instrument. The system can include a distribution system that delivers the postcard presentation instrument from the processing system to a destination. In some embodiments, the system can include a settlement means that settles a transaction involving the postcard presentation instrument.

In another aspect, embodiments provide a presentation instrument assembly that includes a primary component, and a postcard presentation instrument removably matched with the primary component. The postcard presentation instrument can have an information storage medium, and the primary component may include a magazine or a book. In a further aspect, embodiments include a method for providing a presentation instrument for use in a transaction. The method can include associating a unique identifier with a user account, transmitting the unique identifier to a user computer via an electronic communication means. The unique identifier may be suitable for printing as a detectable symbol onto a presentation instrument. The method can also include reading the symbol to recognize the unique identifier, and settling a transaction involving the presentation instrument based on the unique identifier.

Other embodiments of the invention provide a method of including a gift card in a mailing to a customer. The method includes receiving a request to include gift cards in mailings to each member of a group comprising one or more customers. The group includes the customer. The method also includes preparing the mailing. The mailing includes the gift card and the gift card is inactive. The method further includes sending the mailing to the customer and receiving a request from the customer to activate the gift card. The request includes an identifier of the gift card and payment for an amount of value to be assigned to the gift card. The method further includes settling a transaction involving the gift card and a recipient of the gift card. The recipient and the customer are different.

In related embodiments, the value to be assigned to the gift card may be monetary value. The request may include criteria used to determine the group that includes one or more customers. Preparing the mailing may include applying the criteria to data stored at the host computer system to determine the group that includes the one or more customers. Receiving a request to include gift cards in mailings to each member of a group that includes the one or more customers may include receiving the request from a financial institution, retailer, client, and/or customer. The mailing may include an account statement, direct mailing, catalogue mailing, and/or account correspondence.

In other embodiments, a method of including a stored value card in a mailing to a customer includes receiving a request to include stored value cards in mailings to each member of a group that includes one or more customers. The group includes the customer. The method also includes preparing the mailing. The mailing includes the stored value card and the stored value card is inactive. The method also includes sending the mailing to the customer and receiving a request from the customer to activate the card. The request includes an identifier of the card and payment for an amount of monetary value to be assigned to the card.

In further embodiments, a method of including a gift card in a mailing to a customer includes receiving a request from the customer to include an inactive gift card in the mailing and preparing the mailing. The mailing includes the gift card and the gift card is inactive, The method also includes sending the mailing to the customer and receiving a request from the customer to activate the gift card. The request includes an identifier of the gift card and payment for an amount of monetary value to be assigned to the gift card. In some embodiments, the request includes a request to send a plurality of gift cards. At least two of the plurality of gift cards may relate to different merchants. The method may include settling transactions with two different recipients of two different of the plurality of gift cards. Receiving a request from the customer to include an inactive gift card in the mailing may include receiving a request to include a card in each of a plurality of mailings.

In still further embodiments, a computer-readable medium has stored thereon computer-executable instructions for performing a method of including a stored value card in a mailing to a customer. The method includes receiving a request to include stored value cards in mailings to each member of a group that includes one or more customers. The group includes the customer. The method also includes preparing the mailing. The mailing includes the stored value card and the stored value card is inactive. The method also includes sending the mailing to the customer and receiving a request from the customer to activate the card. The request includes an identifier of the card and payment for an amount of monetary value to be assigned to the card.

In still further embodiments, a method of including a stored value card in a mailing to a customer includes a step for receiving a request to include stored value cards in mailings to each member of a group that includes one or more customers. The group includes the customer. The method also includes a step for preparing the mailing. The mailing includes the stored value card and the stored value card is inactive. The method also includes a step for sending the mailing to the customer and a step for receiving a request from the customer to activate the card. The request includes an identifier of the card and payment for an amount of monetary value to be assigned to the card.

In some embodiments, a system for including a stored value card in a mailing to a customer includes mail processing equipment, a processor configured to control the mail processing equipment, and software that programs the processor to receive a request to include stored value cards in mailings to each member of a group that includes one or more customers. The group includes the customer. The software also programs the processor to send control signals to the mail processing equipment to prepare the mailing. The mailing includes the stored value card and the stored value card is inactive. The software also programs the processor to receive a request from the customer to activate the card. The request includes an identifier of the card and payment for an amount of monetary value to be assigned to the card. The request to include stored value cards in mailings to each member of a group comprising one or more customers may include criteria used to determine the group comprising one or more customers. The system may include a data storage arrangement configured to store account information relating to the one or more customers. The software may also program the processor to apply the criteria to the account information to determine the one or more customers.

In some embodiments, a system for including a stored value card in a mailing to a customer includes means for receiving a request to include stored value cards in mailings to each member of a group that includes one or more customers. The group includes the customer. The system also includes means for preparing the mailing. The mailing includes the stored value card and the stored value card is inactive. The system also includes means for sending the mailing to the customer and means for receiving a request from the customer to activate the card. The request includes an identifier of the card and payment for an amount of monetary value to be assigned to the card. The stored value card may be a gift card, in which case the system may include means for settling a transaction involving the gift card and a recipient of the card. The customer and the recipient may be different.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for selectively including stored value cards in mailings to customers according to embodiments of the invention.

FIG. 2 illustrates mail processing equipment used to assemble stored value card mailings according to embodiments of the invention.

FIG. 3 illustrates an exemplary stored value card mailing according to embodiments of the invention.

FIG. 4 illustrates a process for selectively including stored value cards in mailings according to embodiments of the invention, which process may be implemented in the system of FIG. 1.

FIGS. 5A-5C show presentation instruments according to embodiments of the present invention.

FIG. 6 shows a presentation instrument and primary component according to embodiments of the present invention.

FIG. 7 shows a presentation instrument and primary component according to embodiments of the present invention.

FIG. 8 shows a presentation instrument and primary component according to embodiments of the present invention.

FIG. 9 schematically illustrates a method of providing a presentation instrument according to embodiments of the present invention.

FIG. 10 shows a method of providing a presentation instrument for use in a transaction according to embodiments of the present invention.

FIG. 11 shows a system of providing a presentation instrument for use in a transaction according to embodiments of the present invention.

FIG. 12 shows a presentation instrument for use in a transaction according to embodiments of the present invention.

FIG. 13 depicts a presentation instrument and holder according to embodiments of the present invention.

FIG. 14 shows a reader, presentation instrument, and holder according to embodiments of the present invention.

FIG. 15 shows a system of providing a presentation instrument for use in a transaction according to embodiments of the present invention.

### DETAILED DESCRIPTION OF THE INVENTION

According to embodiments of the invention, stored value cards or other presentation instruments are mailed to potential customers for activation and use. In some embodiments, the presentation instruments comprise gift cards that the customer activates and presents to a recipient. The recipient thereafter may use the card for purchases of goods and services. It is appreciated that a presentation instrument can be any of a variety of transaction instruments, including credit cards such as VISA®, MasterCard®, and American Express®, debit cards such as ATM cards, bank cards, prepaid phone cards, airline cards, frequent buyer cards, casino cards, hotel room door access cards, insurance cards, library cards, discount cards, membership cards, entertainment cards, travel cards, supermarket check-out cards, retail store charge cards, gift cards, calendar cards, prepaid debit cards, restaurant tip cards, driver's licenses or other identification cards, various stored value cards, or any other type of financial, healthcare, or transaction presentation instrument, and the like. Exemplary presentation instruments are further discussed in U.S. patent application Ser. No. 09/971,303 filed Oct. 3, 2001 (Attorney Docket No. 020375-003800US), Ser. No. 10/421,604 filed Apr. 22, 2003 (Attorney Docket No. 020375-038000US), Ser. No. 10/922,815 filed Aug. 19, 2004 (Attorney Docket No. 020375-044520US), and Ser. No. 11/155,323 filed Jun. 17, 2005 (Attorney Docket No. 020375-061900US), the entire contents of which are incorporated herein by reference.

As used herein, the term “stored value card” or “presentation instrument” encompasses a presentation instrument that has a pre-determined amount of monetary value or unique identifier associated with it. The value may be physically encoded on the card or may be stored in a database that is accessed through a network when the card is presented for use to determine whether the card has sufficient value for the specific use. The card typically will have an information encoding region on it, which may be a magnetic stripe, a bar code, a “chip,” a radio frequency identification tag (RFID), or any other information encoding region. The term “card” is to be interpreted broadly so as to include fobs and such devices that interact with point-of-sale equipment to settle a transaction. The terms “stored value card” and “presentation instrument” are often used interchangeably throughout the instant disclosure.

In some embodiments, the stored value cards are placed into mailings by a mail processor. Here, the terms “processor” or “processing system” encompasses any entity that assembles mailings, and also encompasses any entity that assembles distribution materials such as presentation instruments and primary components which may include gift cards, magazines, circulars, newspapers, and the like, and which can be distributed via any of a variety of distribution systems. The terms can also emcompass entities which match presentation instruments with primary components. In some embodiments, the processor issues credit cards and other presentation instruments on behalf of its clients. The clients may be retailers, financial institutions, and the like. The presentation instruments may be: general use, network-branded credit cards (e.g., MASTERCARD®, VISA®, and the like); closed loop, private label credit cards (J.C.PENNEY'S®, TOYS-R-US®, STARBUCKS®, and the like); co-branded cards issued jointly by a retailer and a financial institution; co-branded cards issued jointly by two or more retailers; debit cards; gift cards; and the like. The processor also may settle transactions using the cards, send statements to the account holders, maintain the accounts of the account holders, and provide many other services for its clients.

In a specific embodiment, the stored value cards are gift cards. The cards may have no value or may have a predetermined value. In either case, however, the cards are not activated (i.e., “dead” cards). In the process of sending correspondence to the customers (i.e., account holders) of its clients (i.e., card issuers), a processor may insert dead gift cards in the mailings. Any of a number of different entities may cause the gift cards to be included in mailings. For example, a customer may specifically request a gift card for a particular merchant to be mailed to him along with his statement for a credit card of the merchant. In some embodiments the customer may access a web site and schedule gift cards for specific merchants at regular intervals or to correspond with events, such as his child's birthday, and the like. A client of the processor may request gift cards to be mailed to its customers along with their statements. The request may be based on criteria. For example, the client may request that every customer who has made a purchase at a specific retailer within the past six months receive a gift card for that retailer. Other criteria may relate to holidays, events specific to individual customers, a customer's creditworthiness as embodied in a FICO score, and many other criteria.

In some embodiments, a retailer may target market customers by sending gift cards via the processor. The retailer may have a credit card that the processor administers, in which case the retailer may use its own mailings to deliver the gift cards. In other embodiments, the retailer partners with a financial institution or other client of the processor to use its customer base and mailings to deliver the cards. In embodiments such as these, the retailer may be partly or exclusively a catalog retailer, and the mailing may include a catalog. Many other examples are possible.

Once a customer receives a card, the customer typically activates the card. This may involve calling an IVR (i.e., interactive voice response) unit, logging onto a web site, calling a live agent, visiting a merchant, or the like. The customer provides information that identifies the card and a payment method. In embodiments that do not have a pre-established value associated with the card, the customer also provides an amount to load onto the card.

In some embodiments, the customer may present the card to a recipient who then may use the card for purchases of goods or services up to the pre-established amount or the amount loaded by the customer. Transactions involving the card may be settled by the processor. In some embodiments the recipient may add value to the card.

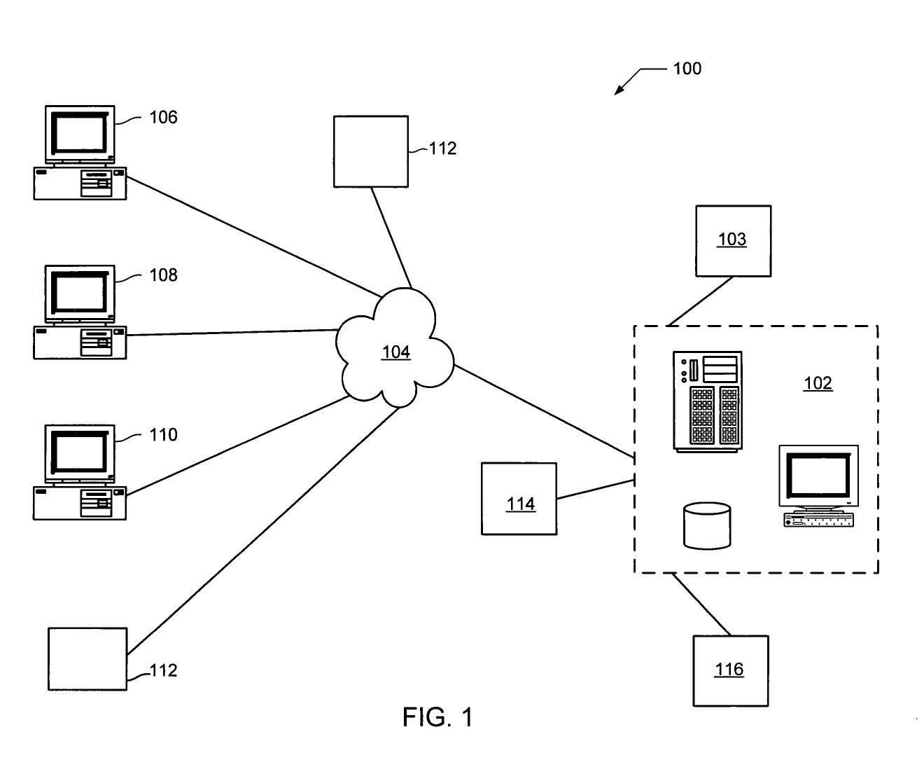

Having described the present invention generally, attention is directed to FIG. 1, which illustrates a system 100 according to the present invention. As will be explained in more detail hereinafter, the system 100 may be used to selectively include stored value cards in mailings to customers. It should be understood that, although the examples used herein relate to stored value cards, this is not a requirement. Other types of presentation instruments may be included in mailings or other distributions, as is apparent to those skilled in the art in light of this disclosure. Exemplary presentation instruments include, without limitation to, credit cards such as VISA®, MasterCard®, and American Express®, debit cards such as ATM cards, bank cards, prepaid phone cards and other phone cards, airline cards, frequent buyer cards, casino cards and other membership cards, hotel room cards and other access cards, insurance cards, library cards, discount cards, entertainment cards, travel cards, supermarket check-out cards, retail store charge cards, reward cards, gift cards, loyalty cards, promotional cards, vending machine cards, incentive cards, calendar cards, prepaid debit cards, toll booth cards, voter cards, restaurant tip cards, driver's licenses or other identification cards, various stored value cards, or any other type of financial, healthcare, identification, or transaction presentation instrument, and the like. A presentation instrument can also be any apparatus that interacts with a point-of-sale or point-of-care system to settle a transaction. Exemplary presentation instruments are further discussed in U.S. patent application Ser. No. 09/971,303 filed Oct. 3, 2001 (Attorney Docket No. 020375-003800US), Ser. No. 10/421,604 filed Apr. 22, 2003 (Attorney Docket No. 020375-038000US), Ser. No. 10/922,815 filed Aug. 19, 2004 (Attorney Docket No. 020375-044520US), Ser. No. 10/959,637 filed Oct. 5, 2004 (Attorney Docket No. 020375-058100US), Ser. No. 11/153,218 filed Jun. 14, 2005 (Attorney Docket No. 020375-061200US), Ser. No. 11/155,323 filed Jun. 17, 2005 (Attorney Docket No. 020375-061900US), and Ser. No. 11/233,947 filed Sep. 22, 2005, (Attorney Docket No. 020375-068200US), the entire contents of each of which are incorporated herein by reference. Further, the system 100 of FIG. 1 should not be considered limiting. Those skilled in the art will realize equivalent arrangements in light of the disclosure herein.

The system 100 includes a host computer system 102. The host computer system 102 may include, for example, server computers, personal computers, workstations, web servers, and/or other suitable computing devices. The host computer system 102 includes application software that programs the host computer system 102 to perform one or more functions according to the present invention. For example, application software resident on the host computer system 102 may program the host computer system 102 to selectively include stored value cards in mailings to customers. The host computer system 102 may include one or more of the aforementioned computing devices, as well as storage devices such as databases, disk drives, optical drives, and the like. The storage device may include solid state memory, such as RAM, ROM, PROM, and the like, magnetic memory, such as disc drives, tape storage, and the like, and/or optical memory, such as DVD. The host computer system 102 may be fully located within a single facility or distributed geographically, in which case a network may be used to integrate the host computer system 102. Many other examples are possible and apparent to those skilled in the art in light of this disclosure.

In a specific embodiment, the host computer system includes a mainframe that maintains presentation instrument accounts and, in combination with a financial transaction processing network, settles transactions in which the presentation instruments are used.

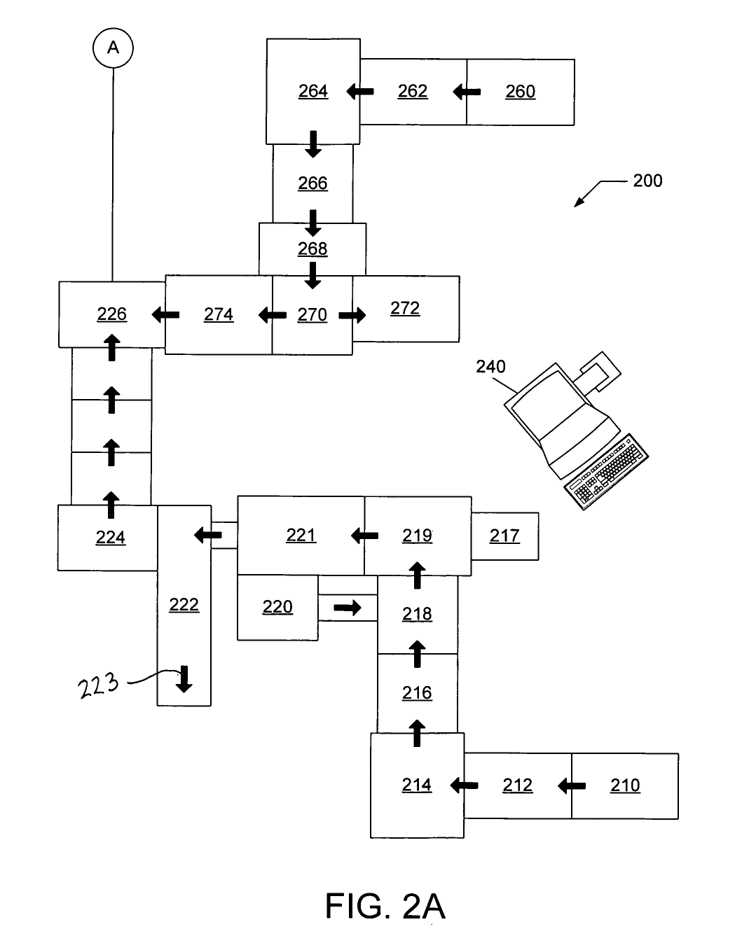

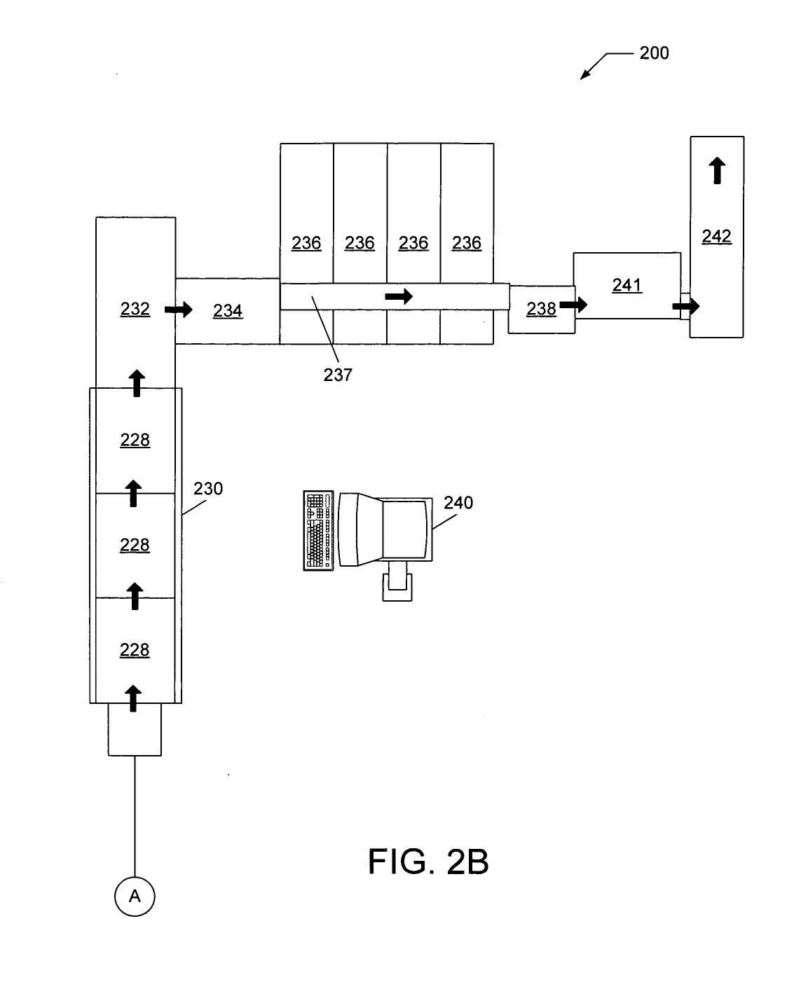

A processing system 103 is associated with the host computer system. The processing system 103 is responsive to the host computer system and performs such functions as: embossing presentation instruments; enclosing the presentation instruments in mailings to customers or otherwise matching presentation instruments with distribution materials such as postcards and magazines; printing and mailing statements to customers; including inserts and other items in mailings to customers; preparing and mailing other correspondence to customers; and the like. The processing system 103 will be explained in more detail hereinafter with respect to FIG. 2.

The system 100 also includes a communication network 104. The network 104 may be the Internet, an intranet, a wide area network (WAN), a local area network (LAN), a virtual private network, any combination of the foregoing, or the like. The network 104 may include both wired and wireless connections, including optical links. In some embodiments, the network 104 includes a financial transaction processing network. Through the network 104, client computers 106, customer computers 108, retailer computers 110, and the like communicate with the host computer system 102.

The client computers 106, customer computers 108, and retailer computers 10 each may be any device capable of interacting with the host computer system 102 through a communication link, such as the network 104. For example, the client computers 106, customer computers 108, and retailer computers 10 may be personal computers, workstations, servers, and/or the like. Among other things, through the network 104, the client computers 106, customer computers 108, and retailer computers 110 access web pages at the host computer system 102.

The system 100 also includes point-of-sale devices 112 through which customers may settle transactions a merchant locations using the presentation instruments described herein. The transactions then may be processed through the network 104, as will be appreciated by those skilled in the art.

The system 100 also includes an interactive voice response (IVR) unit 114, in communication with the host computer system 102, through which customers may activate stored value cards. The system 100 also includes a live agent response unit 116 for the same purpose.

Thus, when a customer receives a stored value card and wishes to activate it, the customer may use his customer computer 108 to access a web server associated with the host computer system 102 and provide appropriate information for activating the card. Alternatively, the customer may use a telephone to access either the IVR 114 or the live agent response unit 116 to activate the card. The web server, IVR, or the agent obtain the required information from the customer and create an account at the host computer system by creating a record that relates to the card on a database at the host computer system. Thereafter, transaction requests using the card that are processed via the network 104 use the stored information to settle the transaction. Those skilled in the art will appreciate, however, that it is not necessary for transactions using the card to be settled using the network 104. The system may be used to distribute stored valued cards that are settled on other networks.

Turning now to FIGS. 2A and 2B, an exemplary processing system will be described in greater detail. In particular, FIGS. 2A and 2B depict a simplified schematic of a processing and inserting system 200 useful in relation to the present invention. The processing system 200 may comprise the processing system 103 of FIG. 1. Those skilled in the art will appreciate that this exemplary embodiment is merely illustrative of myriad possible embodiments according to the present invention.

System 200 includes a series of stations adapted to produce an envelope stuffed with a desired number of primary components and/or inserts. In some embodiments, system 200 may be adapted to match a presentation instrument with a primary component. System 200 can either receive folded primary components and/or inserts from a folding system, or can include printing and/or folding capability incorporated into the system. For example, system can include printing capability to print a logo on a card stock material, applicating capability to apply a magnetic stripe to the card stock material, and perforating capability to perforate an area of the card stock material corresponding to a presentation instrument. In the case shown in FIGS. 2A and 2B, system 200 includes a printer 210 adapted to print alpha numeric characters on a statement, a sheet of paper, a card carrier, or the like. Printer 210 prints information such as an account number, a customer name and mailing address, a monetary account limit, and the like, and further may print one or more bar codes. In one case, at least one of the bar codes identifies which inserts, from a plurality of different inserts, are to be sent to the customer with the statement or card.

The primary components (not shown) travel down a belt 212 and are stacked in a stacking unit 214. The primary components are then sequentially drawn from stacking unit 214 into unit 216. In one case, unit 216 includes a bar code reader for reading a bar code or other identification mark on the primary component. The bar code may, for example, identify which inserts are to be later matched up with the primary component. In another case, unit 216 also reads a number, such as a three digit number, associated with the primary component to facilitate proper matching with a card type insert having a corresponding number.

In one case, the primary component is transferred from unit 216 into unit 218. A card type insert is received from unit 220 and matched with the corresponding primary component in unit 218. In one case, the card type insert is glued, placed in slots or otherwise affixed to the primary component in unit 218. In a similar case where the primary component includes a magazine, for example, a card type insert can be inserted between the pages of the magazine. The mated card primary component and card are transferred to unit 219. If a processing error has occurred, unit 219 deflects the card and card primary component into a bypass tray or receiving area 217. Processing errors may include, for example, mismatched cards and card primary components, and the like. If no error has occurred, unit 219 deflects the card and card primary component into a folding unit 221. As previously noted, the folding unit can be implemented separately. From the folding unit, the primary component and associated card can be forwarded a card detection assembly, that when an error is detected, such as too many cards or a missing card(s), the primary component is transferred to a bypass tray or receiving area in the direction shown by arrow 223. Transfer may occur along a conveyor belt, a track, or the like.

In one particular case, system 200 operates to place card type inserts in primary components, but is not used for processing further paper inserts. In this case, the primary component and associated card type insert(s) are passed down conveyor 222 in the direction of arrow 223, and removed from system 200. The primary components may, if desired, be transported to an envelope stuffing apparatus, a mail room or the like. In another case, system 200 operates to place paper insert sets with primary components, but not card type inserts. In yet another case, system 200 operates to place both card and paper type inserts with primary components. In such cases, if the card detection assembly does not indicate an error, primary components are then passed to a paddle wheel assembly 224 to continue processing. The paddle wheel 224 operates to place the primary component and card type insert(s) on a track or conveyor belt 230. The primary components proceed down belt 230, passing under a second paddle wheel assembly 226. In one case, second paddle wheel assembly 226 places a second insert on top of the primary components as they pass underneath. For example, the second insert may be an advertisement, additional information pertinent to the recipient or the like.

As shown in FIG. 2A, a second printer 260 is adapted to print out the numerical characters and/or bar codes on an insert or a set of inserts. For example, printer 260 may further print one or more pages of advertisements or other inserts for a given recipient. In one case, printer 260 is electrically coupled to the bar code reader in unit 216. In this manner, bar code reader 216 may read the bar code or other identification mark on the primary component processed through unit 216 and inform printer 260 that an insert set is needed to be matched up with the primary component. In one case, controller 240 facilitates the communication between unit 216 and printer 260. The printed insert set passes from printer 260 along a belt 262 and into a stacking unit 264. Stacking unit 264 is similar to stacking unit 214, and performs similar functions. For example, stacking unit 264 stacks a plurality of primary components, and then passes the primary components one at a time to unit 266. Unit 266 is similar to unit 216, and may include a bar code reader for reading a bar code or other identification marks on the primary component. The insert then passes to unit 268, where the insert can be folded. The insert passes into unit 270, which in one case is a deflection unit 270 similar to unit 219 described above. Deflection unit 270 passes inserts to bypass station 272 in the event the insert is not to be matched with the present primary component. For example, bypass unit 272 receives inserts that may have been printed in error. Deflection unit 270 further directs inserts to belt 274 for transporting inserts to second paddlewheel 226. The insert is then matched with the primary component as described above.

In some embodiments, printer 260 is not included as all inserts are provided from pre-prepared inserts loaded into one or more insert bays or holders 228 that can be loaded with a variety of inserts. Alternatively, both printed and pre-prepared inserts can be included. The matched insert sets and primary components proceed along a track or conveyor belt 230, passing under one or more insert bays 228. FIG. 2B depicts three (3) insert bays 228, although a larger or smaller number of bays 228 also may be used within the scope of the present invention. In one particular case, system 200 includes as many as one hundred insert bays 228.

Insert bays 228 contain inserts, such as paper advertisements, catalogs, and informational inserts. These inserts may be added to a particular recipient's stack of primary components and/or card type inserts passing beneath on belt 230. Inserts contained within bays 228 may be selectively chosen based upon a number of criteria, including customer interest and other factors. For the system 200 shown in FIG. 2B having three bays 228, some recipients may receive all three inserts, other recipients may receive less than three inserts, while still other recipients may receive no inserts. The selected combination of inserts forms the insert set that is provided to the given recipient. In some cases, the insert set can include inserts from inert bays 228, the aforementioned card type inserts, and/or printed inserts created on printer 260.

In one case, the primary components traverse along belt 230 positioned underneath bays 228. In one case, belt 230 provides continuous, fluid movement of the statements. In another case, belt 230 provides incremental movement of the primary components, with each primary component stopping below each bin 228. Inserts desired to be matched with a particular recipient's primary component are pulled from bays 228 and placed atop the recipient's statement. Upon reaching the end of belt 230, the stack of primary components and associated inserts being sent to the recipient are transferred to unit 232 for insertion into an envelope.

The now stuffed envelope, containing a particular recipient's primary component, printed paper inserts, pre-prepared inserts, and/or card type inserts is sent to an envelope sealing unit 234. Envelope sealing unit 234 sprays a mist of water or other fluid on the envelope flap and proceeds to seal the moistened flap. Unit 234 further flips the stuffed envelope over to expose the envelope front. In one case, envelopes processed through system 200 are windowed envelopes, with information printed on the primary component or other insert exposed through the envelope window. The envelopes proceed into one or more diverters 236. Diverters 236 may divert stuffed envelopes for a variety of reasons, including, but not limited to, additional processing errors, and envelopes requiring special or additional handling. In one case, at least one diverter 236 is used for stuffed envelopes to be sent by overnight courier, such as Federal Express. In another case, at least one diverter is used to receive envelopes intended to be sent by airmail, or the like. Envelopes intended for standard mail delivery, such as by the U.S. Postal Service First Class Delivery, are put past diverters 236 along belt or track 237 and proceed to a first postage meter 238. First postage meter 238 applies a one ounce postage to envelopes requiring only a single ounce of postage. Envelopes proceed to a second postage meter unit 241, in which a second ounce of postage is applied. Alternatively, the entire two ounce postage is applied in second postage meter station 241, with the envelope passing first postage meter station 238 without receiving postage. The envelopes have now been properly stuffed, sealed, and postaged and proceed to an output station 242. The envelopes then may be received from output station 242 for delivery to the intended customers.

System 200, in one case, includes one or more controllers 240 for monitoring and/or controlling the process through system 200. The controller may receive instructions and commands from the host computer system 102 of FIG. 1. An operator may view the status of documents on the computer screen associated with a particular controller 240, and/or input data as needed into controller 240 to facilitate operation of system 200. Further, controllers 240 facilitate the coordination between printers 210, 260, bar code readers in system 200 and insert bays 228, to ensure each recipient receives the desired inset set. Additional information about an inserter similar to that previously described can be found in U.S. Pat. No. 6,802,500, the contents of which are incorporated herein by reference for all purposes. Based on the disclosure provided herein, one of ordinary skill in the art will appreciate that a variety of inserters and/or processing systems can be used in relation to the present invention. For example, another insertion system is disclosed in U.S. Pat. No. 6,670,569, the contents of which are incorporated herein by reference for all purposes.

Thus, in a specific embodiment, the primary items discussed here may be statements and the inserts may be gift cards. In another specific embodiment, the primary components may be gift cards and the inserts may be catalogs. Many other examples are possible and apparent to those skilled in the art in light of this disclosure.

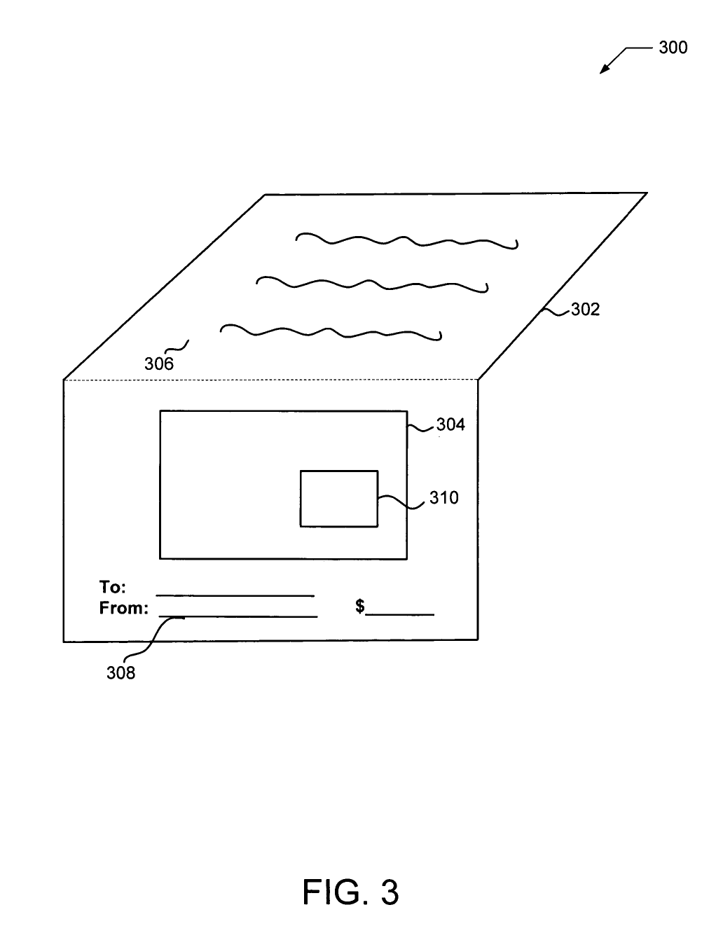

Attention is directed to FIG. 3, which illustrates an embodiment of a stored value card insert 300 according to embodiments of the invention. The insert 300 includes a card carrier 302 and a stored value card 304, in this case a gift card. The card 304 may be attached to the carrier 302 in any of a number of well known ways. The carrier 302 includes instructions 306 for activating the card and blanks 308 into which the customer may enter information such as the recipient and the amount the customer loaded on the card. Conveniently the carrier may be perforated so that the activation instructions section may be separated from the card section. The card may include a logo or brand 310.

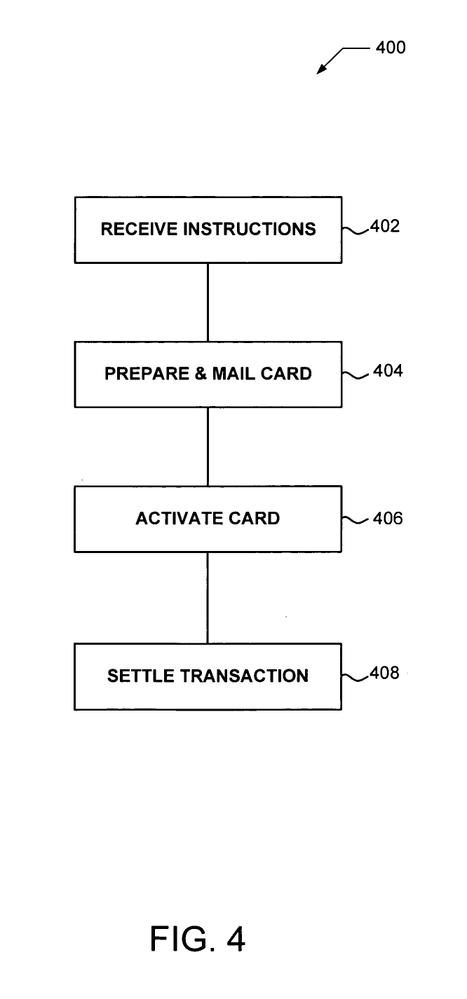

Attention is directed to FIG. 4, which illustrates an embodiment of a method 400 of selectively including stored value cards in mailings according to embodiments of the invention. The method may be implemented in the system of FIG. 1 or other appropriate system. The method 400 is merely exemplary; other embodiments may have more, fewer, or different operations. Further, the operations may be conducted in a different order than that illustrated here.

The method begins at block 402. At this location, a request is received at a host computer system to include stored value card inserts with one or more mailings. The host computer system is operated by a processing entity (“processor”). The request may originate from a client of the processor (e.g., card issuer), a retailer, a customer of the processor's client, or other entity. In most embodiments, however, the entity for whose benefit the mailing is prepared allows the insert to be included in the mailing, either for a fee or in cooperation with the requesting entity.

The request may come in any of a number of forms. The requesting entity may use a network, such as the network 104 of FIG. 1, to access a web server of the host computer system. By interacting with the web server, the entity may identify, either directly or via criteria, customers to whom the insert should be sent. As mentioned previously, the requesting entity may be a customer merely requesting a card for his own benefit. The customer may, using the web server, set up a recurring delivery schedule for such cards (e.g., every year just prior to Secretary's Day). The customer may request a number of cards, each to be delivered around a specific date. The cards need not be identical; the cards may each be useable at a different merchant.

At block 404, the mailing is prepared. This may involve using the processing system 103 of FIG. 1. In determining customers to whom the cards should be directed, the host computer may use the criteria to identify suitable customers. For example, the criteria may include parameters to send cards to all customers having an annual income level higher than $50K who have made a purchase at a specific retailer in the last six months. The criteria may be applied to data, such as account information, stored at the processor's host computer system. In some embodiments, a decisioning engine is used to parse the criteria and identify customers to whom cards are to be sent. Such a decision engine is described more fully in previously-incorporated U.S. Pat. No. 6,829,519, the contents of which are incorporated herein by reference for all purposes.

Once the customers have been identified, processing equipment, such as that described with respect to FIGS. 2A and 2B, may be used to selectively include cards in mailings to the customers. The mailings may be a regular mailing, such as an account statement, or the like, or may be targeted marketing specifically intended to deliver the card. Many other examples are possible.

At block 406, an activation request is received. A customer contacts the host computer to request activation of a card. The customer may contact the host computer system via a network and interact with a web server. In other embodiments, the customer contacts an IVR or a live agent and activates the card. In some embodiments, activating a card comprises establishing an account and storing a record of the account at the host computer system. The activation request may include an amount of value to be assigned to the card, since some cards do not have predetermined value.

At block 408, transactions involving the card are settled. This would be the case if the processor that issues the card also settles transactions using the card, which is not necessarily the case. Transactions involving the card may be settled by another processor's network.

In a specific embodiment of the foregoing method, a retailer (Toys-R-Us®, for example) partners with a financial institution (Chase®, for example) to provide its customers with a co-branded gift card that may be used for purchases at Toys-R-Us® stores or for Toys-R-Us® merchandise ordered via a catalog or an electronic storefront (i.e., web site). The financial institution happens to be the card issuer for the retailer's private label card. The financial institution instructs the entity that processes its credit card transactions (“processor”) to, with each customer's account statement, send a gift card to each of its customers who have purchased at the retailer in the last 12 months. The financial institution further asks that customers living in a zip code more than 50 miles from a location of the retailer also receive a catalog of the retailer. The processor prepares the mailings and distributes the cards. Thereafter, the processor may receive requests to activate the cards, in which case, the processor receives payment and establishes the related accounts. In this embodiment, the processor also processes transactions involving the gift card. Thus, when a recipient of the card uses the card, the processor settles the transaction.

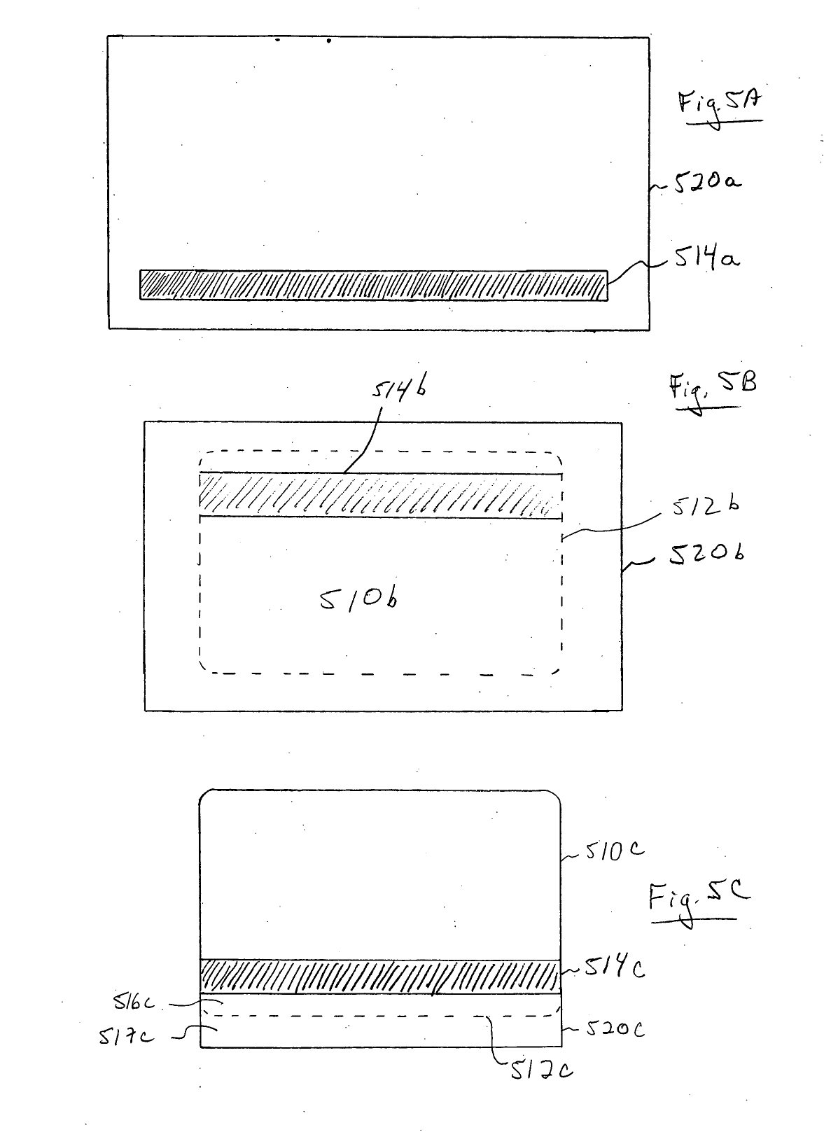

In addition to approaches that insert a presentation instrument in a primary component, or otherwise provide a matched presentation instrument and primary component, the present invention also provides embodiments where the primary component is synonymous with the presentation instrument. For example, FIG. 5A illustrates a postcard mailer 520a which can serve as a presentation instrument. In this sense, postcard mailer 520a represents a postcard presentation instrument, or more generally a primary component presentation instrument. Typically, such postcards and other primary components will include or be affixed with an information storage medium 514a containing a unique identifier. In some embodiments, the information storage medium may include a magnetic stripe, a bar code, or an RFID device, for example. Similar embodiments may be provided for other primary components, including fold-over postcards, magazines, inserts, flyers, and the like. Such presentation instruments can provide additional surface area for writing and other graphics as compared to some standard-size presentation instruments. Presentation instruments and primary components can be fabricated from any of a variety of materials, including paper card stock, plastic such as polyvinyl chloride (PVC), and the like.

Another embodiment of a presentation instrument provided by the present invention is illustrated in FIG. 5B. Presentation instrument 510b can be framed by or otherwise attached with a primary component such as a postcard mailer 520b, via a perforation 512b. Presentation instrument 510b includes an information storage medium such as a magnetic stripe 514b. In some embodiments, instead of an edge of presentation instrument 510b being attached with postcard mailer 520b via perforation 512b, a surface of presentation instrument 510b can be attached with postcard mailer 520b via a removable glue or other adhesive. In related embodiments, postcard mailer 520b may include a logo, a mailing address, or any other desired advertising or routing information. In some cases, presentation instrument 510b or postcard mailer 520b may include written instructions for use.

Still another embodiment of a presentation instrument provided by the present invention is illustrated in FIG. 5C. Presentation instrument 510c can be attached with a primary component such as a mailer 520c, via a perforation 512c. Presentation instrument 510c includes an information storage medium such as a magnetic stripe 514c. In some embodiments, instead of an edge of presentation instrument 510c being attached with mailer 520c via perforation 512c, a surface of presentation instrument 510c can be attached with mailer 520c via a removable glue or other adhesive. In related embodiments, mailer 520c may include a logo, a mailing address, or any other desired advertising or routing information. In some cases, presentation instrument 510c or mailer 520c may include written instructions for use. It is appreciated that mailer 520c may provide protection to presentation instrument 510c from unwanted bending, folding, or other mutilation. For example, various factors may act to mangle or crush items that are sent though the mail, or inserted into newspapers, circulars, or magazines. As seen in FIG. 5C, a corner 517c of mailer 520c can absorb such impacts, thus maintaining the structural integrity of corner 516c of instrument 510c. Thus, when mailer 520c is removed, instrument 510c can be accurately read by sensors such as those found in standard card readers. The mailer 520b of FIG. 5B can provide similar protection for instrument 510b.

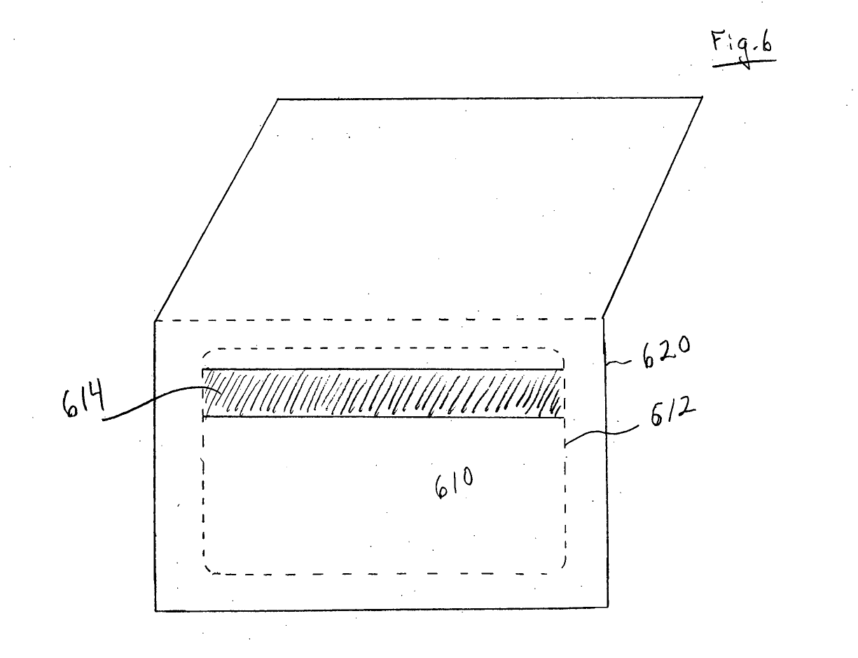

FIG. 6 illustrates another embodiment of a presentation instrument 610 coupled with a fold-over postcard mailer 620. Presentation instrument 610 can be framed by or otherwise attached with postcard mailer 620 via a perforation 612. Presentation instrument 610 includes an information storage medium such as a magnetic stripe 614. In some embodiments, instead of an edge of presentation instrument 610 being attached with postcard mailer 620 via perforation 612, a surface of presentation instrument 610 can be attached with postcard mailer 620 via a removable glue or other adhesive. In related embodiments, postcard mailer 620 may include a logo, a mailing address, or any other desired advertising or routing information. In some cases, presentation instrument 610 or postcard mailer 620 may include written instructions for use.

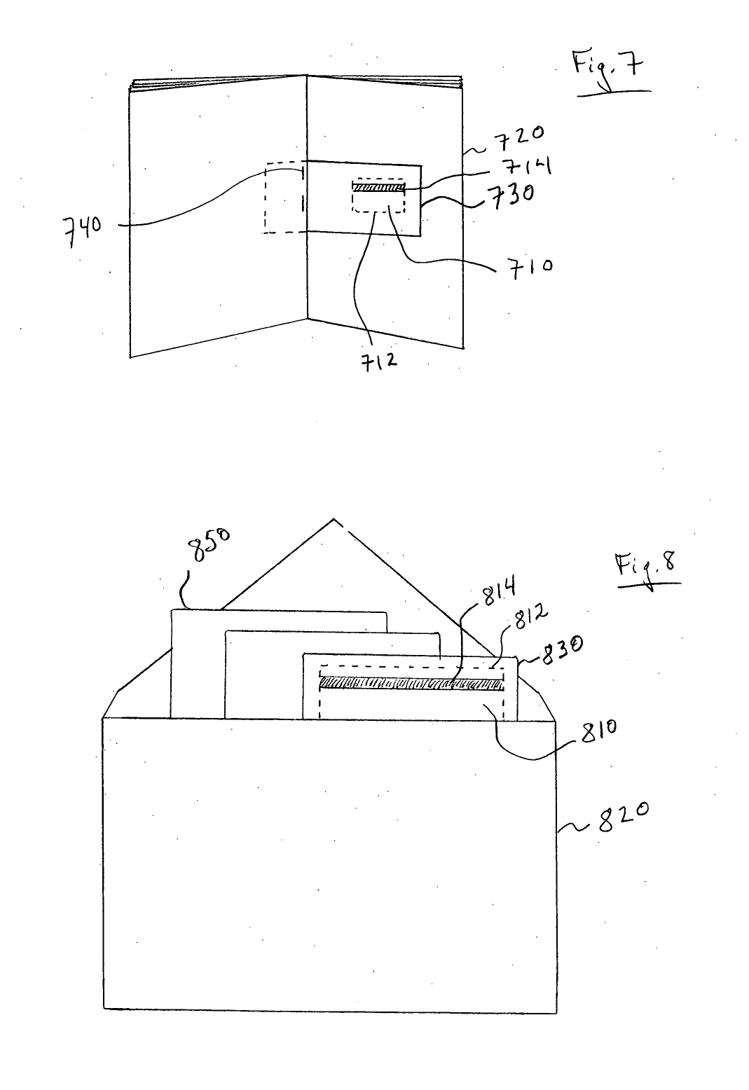

A matched presentation instrument and primary component may also be matched with additional types of primary components, such as a magazines. As seen in FIG. 7, presentation instrument 710 is matched with magazine insert 730, and presentation instrument 710 and magazine insert 730 are matched with magazine 720. In some embodiments, presentation instrument 710 can be framed by or otherwise attached with a magazine insert 730 via a perforation 712. Presentation instrument 710 includes an information storage medium such as a magnetic stripe 714. In some embodiments, instead of an edge of presentation instrument 710 being attached with magazine insert 730 via perforation 712, a surface of presentation instrument 710 can be attached with magazine insert 730 via a removable glue or other adhesive. In related embodiments, magazine insert 730 may include a logo or any other desired advertising or informational feature. In some cases, presentation instrument 710 or magazine insert 730 may include written instructions for use. Presentation instrument 710 and magazine insert 730 may be placed between two pages of the magazine. In some embodiments, presentation instrument 710 may be coupled or affixed with a page of the magazine, and may or may not be attached with a magazine insert 730. As shown here, magazine insert 730 is coupled with magazine 720 via one or more fasteners 740, which can be, for example, staples. In some embodiments, a primary component such as a magazine may be matched with a primary component presentation instrument of the type described in reference to FIG. 5A, or with a matched primary component and presentation instrument assembly of the type described in reference to FIGS. 5B and 5C, and FIG. 6.

In the embodiment depicted in FIG. 8, presentation instrument 810 is matched with value pack mailer 820. In some embodiments, presentation instrument 810 can be framed by or otherwise attached with a value pack insert 830 via a perforation 812. Presentation instrument 810 includes an information storage medium such as a magnetic stripe 814. In some embodiments, instead of an edge of presentation instrument 810 being attached with magazine insert 830 via perforation 812, a surface of presentation instrument 810 can be attached with magazine insert 830 via a removable glue or other adhesive. In related embodiments, value pack insert 830 may include a logo or any other desired advertising or informational feature. In some cases, presentation instrument 810 or value pack insert 830 may include written instructions for use. Presentation instrument 810 and value pack insert 830 may be placed inside of value pack mailer 820 along with other inserts 850. In some embodiments, presentation instrument 810 may or may not be attached with a value pack insert 830.

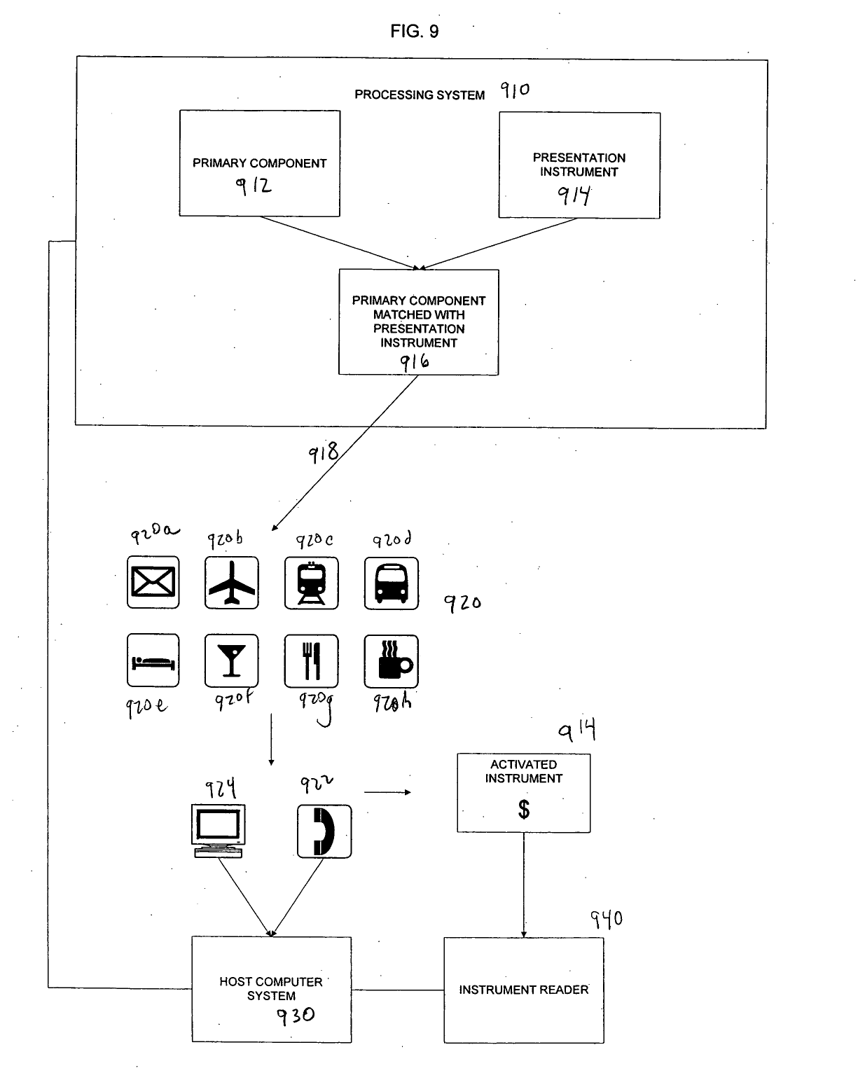

FIG. 9 shows a schematic flow chart for providing a presentation instrument for use in a transaction. Processing system 910 matches primary component 912 with presentation instrument 914. Typically, presentation instrument 914 will include an information storage medium upon which is stored a unique identifier. As shown here, presentation instrument 914 is inactive when matched with primary component 912. The matched primary component and presentation instrument 916 can be delivered, as represented by arrow 918, to a destination 920 via a distribution system. The present invention also contemplates delivery of a primary component instrument of the type discussed in reference to FIG. 5A. Exemplary distribution systems include public postal systems, private postal systems, courier services, and the like. Exemplary destinations include business, residential, and post office mailboxes 920a, and transportation system locations such as airports 920b, railway stations 920c, and bus stations 920d. Other destinations include service or retail outlet locations such as hotels 920e, cocktail lounges 920f, restaurants 920g, and coffee shops 920h. Still further destinations include sidewalk locations, roadside locations, and residential and business address locations. The present invention contemplates any of a wide variety of primary components, including postcards, consumer and business magazines such as People®, Newsweek®, Better Homes and Gardens®, and Car and Driver®, circulars, books, newspapers, value pack mailers, periodicals, newsletters, journals, publications, flyers, subscription notices, statements, invoices, inserts, mass mailers, advertisements including directed and targeted advertisements, drop-ship packages, consumer products such as CD and DVD's, breakfast cereal boxes, sporting goods merchandise, pet food packages, nutritional and vitamin supplements, packages sent from distributors or retailers such as Amazon.com® and Eddie Bauer®, and the like.

In some embodiments, a customer will receive a matched primary component and presentation instrument 916 at destination 920; and then submit a request to host computer system 930 activate presentation instrument 914. Such a request can be made via any of a variety of communication modalities, including telephone 922, Internet 924, facsimile, postal or courier service, and the like. Often, such a request will be accompanied by a payment or promise of payment from the customer. Host computer system 930 can then associate an activated status or value amount with the unique identifier that is stored on an information storage medium of presentation instrument 914. Once activated, presentation instrument 914 may be used by the customer to settle a transaction. In some embodiments, presentation instrument 914 may be activated prior to matching with primary component 912. In some embodiments, presentation instrument 914 may be activated after subsequent to matching with primary component 912, but prior to distribution to destination 920. Activation may be effected by any of a variety of entities, including a customer, a card issuer, a retailer, a distributor, a financial institution, a primary component manufacturer, or any entity or person or combination thereof associated with the primary component or the presentation instrument. In some embodiments, one or more of these persons or entities may pre-load a presentation instrument with a currency amount or some other indication of value that can be exchanged or presented for a good or service.

Often, such settlements are conducted via an instrument reader 940 which can communicate with host computer system 930. Settlement may also occur via telephone, Internet, or via any other suitable communication modality. In some embodiments, the customer may give or sell the activated presentation instrument 914 to a recipient, who can then use presentation instrument 914 to settle a transaction. For example, a customer may retrieve a matched magazine and gift card 916 (e.g. Starbucks® gift card matched with People® magazine) from a backseat pocket of an airplane during a flight. The customer may then dial a host computer system 930 telephone number which is printed on gift card 914, enter a unique identifier or activation code associated with gift card 914, and submit a request to activate gift card 914. The customer may then present the activated gift card 914 to a recipient, who may use activated gift card 914 to purchase a product or service, or to settle a transaction. In some embodiments, the customer may use activated gift card 914 to purchase a product or service, or to settle a transaction. Advantageously, presentation instrument activity can generate large amounts of useful marketing data. Host computer system 930 may be configured to store, track, or otherwise analyze activation activity or presentation instrument usage. For example, host computer system 930 may collect data related to the date, location, nature, and value of a transaction settled with a presentation instrument. Host computer system 930 may also collect data related to the date, location, nature, and value associated with activation and instrument loading. Host computer system 930 may analyze the efficiency and consumer or recipient usage associated with certain distributions systems, presentation instruments, and primary components.

In some cases, multiple copies of a presentation instrument may be matched with a primary component. Each of these presentation instruments may include an information storage medium containing the same unique identifier, such that each card may be used in connection with a single account associated with the unique identifier. Thus, a customer may use one of the cards to activate the account with a certain monetary value, and then provide card copies to several recipients who may then use the cards to settle transactions against the account. Likewise, a card recipient may use the card to further load value onto the account.

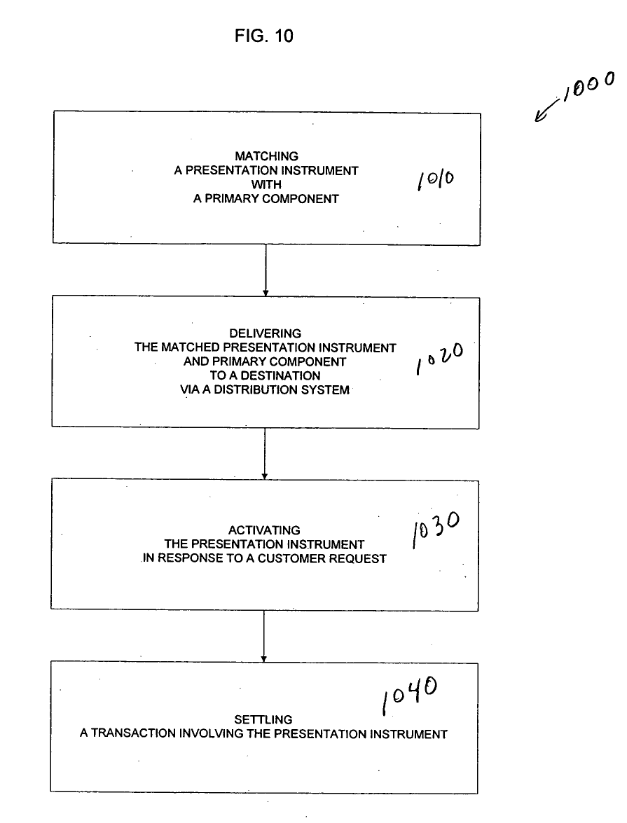

FIG. 10 illustrates an exemplary method 1000 of providing a presentation instrument for use in a transaction, according to one embodiment of the present invention. Method 1000 includes matching a presentation instrument with a primary component, as indicated by step 1010. For example, insert selecting systems and methods such as those described in previously incorporated U.S. Pat. No. 6,829,519 may be used to match a presentation instrument with a primary component. Method 1000 also includes delivering the matched presentation instrument and primary component to a destination via a distribution system, as indicated by step 1020. In some embodiments, the method may include delivering a primary component presentation instrument of the type discussed in relation to FIG. 5A. Method 1000 further includes activating the presentation instrument in response to a request, as indicated by step 1030. As previously discussed, presentation instrument may be activated at any stage. Similarly, presentation instrument may be activated in response to a request from any of a variety of entities, or may be activated when manufactured. Method 1000 also includes settling a transaction involving the presentation instrument, as indicated by step 1040.

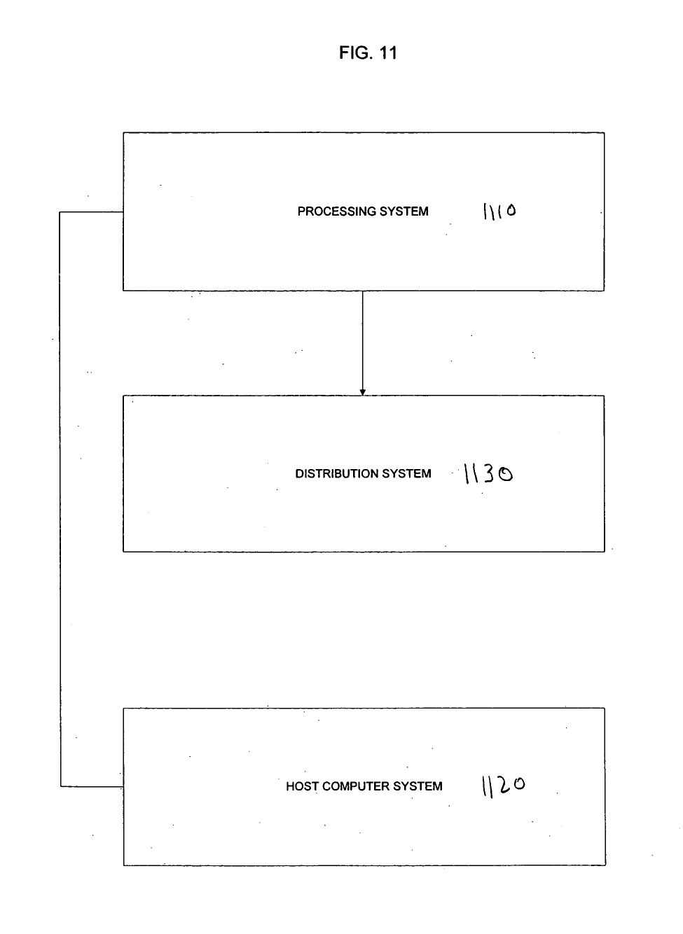

A system embodiment for providing a presentation instrument for use in a transaction is illustrated in FIG. 11. System 1100 includes a processing system 1110 that matches a presentation instrument with a primary component, and a host computer system 1120 that is configured to receive an activation request from a customer. Host computer system may also be configured to process or facilitate a settlement involving the presentation instrument. Processing system 1110 may also include production capability to manufacture presentation instruments, primary components, primary component presentation instruments, or any combination thereof. In some embodiments, system 1100 includes or interfaces with a distribution system 1130 that distributes a matched presentation instrument and primary component, or a primary component presentation instrument, to a destination.

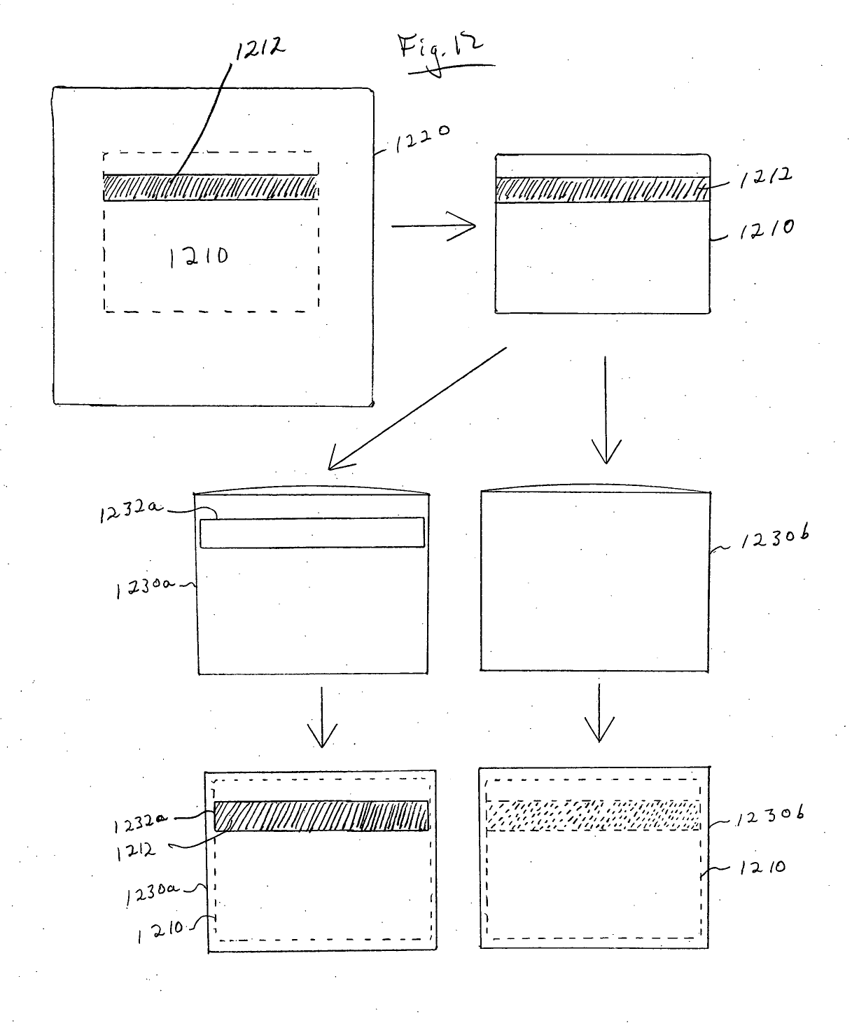

In some embodiments, a presentation instrument may be fabricated from a paper card or plastic stock, or another material that is sufficiently thin and flexible such that it may not be optimally suitable for scanning by some standard card swipe readers. Advantageously, the present invention provides an instrument holder or sleeve that may be used with such instruments. As seen in FIG. 12, a presentation instrument 1210 having a magnetic stripe 1212 can be separated from a primary component 1220 and inserted into an instrument holder 1230a or 1230b. Instrument holder 1230a includes a window 1232a that aligns with magnetic stripe of presentation instrument 1210. The coupled instrument holder 1230a or 1230b and presentation instrument 1210 can then be swiped through a card swipe reader such as a point of sale terminal. The combined thickness of presentation instrument 1210 and instrument holder 1230a or 1230b can be designed for efficient contact with a card reader. For example, the thickness of holder 1230a or 1230b can urge or otherwise place magnetic stripe sufficiently close to a reading means of card reader to ensure accurate instrument reading. Such holders or sleeves may also be useful for protecting presentation instrument 1210 against undesired folding, or from various environmental or other damaging factors.

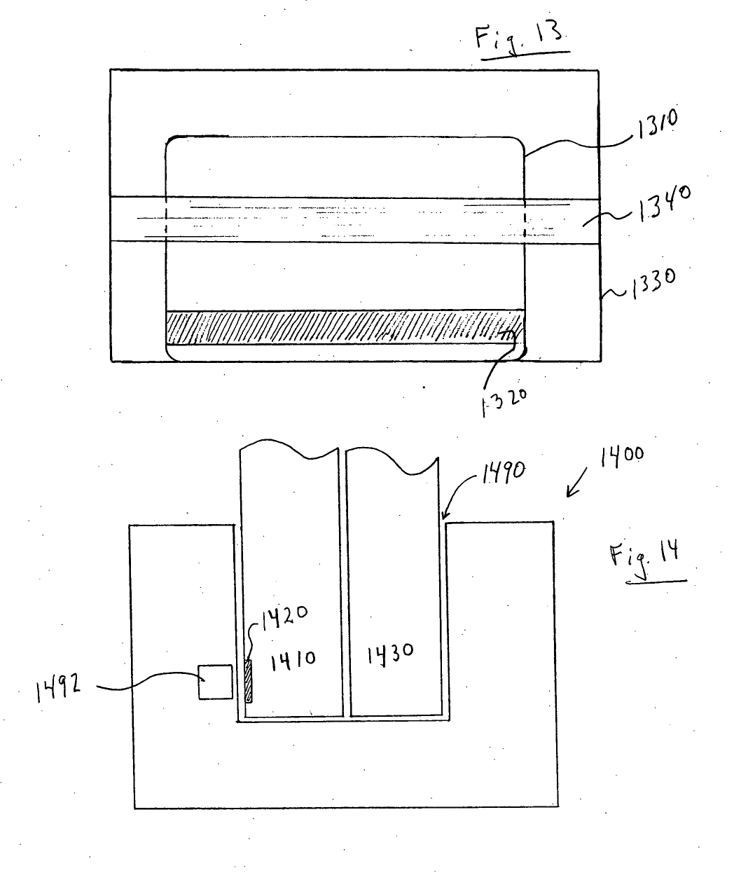

Another embodiment of a holder provided by the present invention is shown in FIG. 13. Here, presentation instrument 1310 is attached or coupled with holder 1330 via a fastener means such as an elastic band 1340. This arrangement can easily be swiped through a card reader. FIG. 14 illustrates a cross sectional view of card reader 1400, which includes a swipe slot 1490 and a sensor 1492. As coupled instrument 1410 and holder 1430 are passed through slot 1492, holder 1430 acts to ensure that magnetic stripe 1420 of instrument 1420 is sufficiently close to sensor 1492 for an accurate reading.

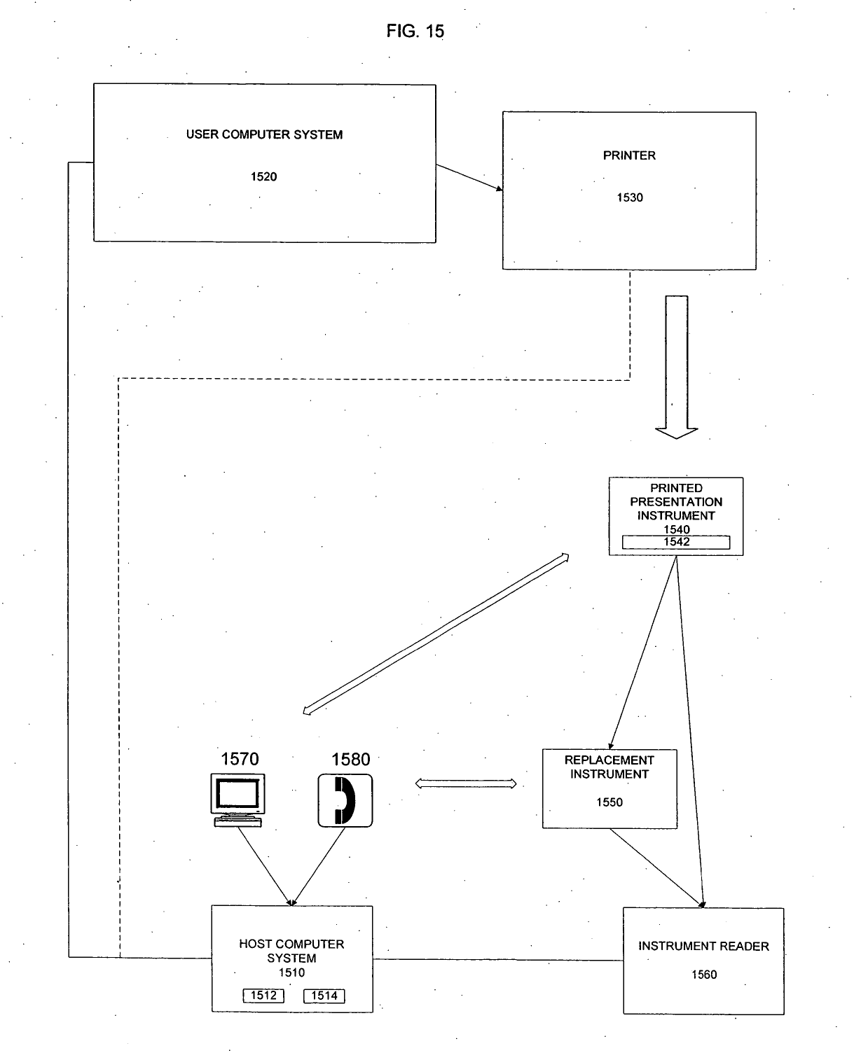

FIG. 15 shows a schematic flow chart for providing a presentation instrument for use in a transaction. Typically, host computer system 1510 associates a unique account identifier 1512 with a user account 1514. Host computer system 1510 receives a request for a printed presentation instrument 1540 from user computer system 1520. In response to the request, host computer system 1510 transmits unique identifier 1512 to user computer system 1520, and user computer system 1520 instructs printer 1530 to print a detectable symbol 1542 on presentation instrument 1540. Detectable symbol 1542 is associated with unique identifier 1512, and typically includes a bar code symbol or other machine readable mark. A presentation instrument user can then provide printed presentation instrument 1542 to a merchant or other entity to settle a transaction. Often, settling a transaction can involve reading detectable symbol 1542 with an instrument reader 1560 that can communicate with host computer system 1510.

In some instances, host computer 1510 may transmit unique identifier 1512 directly to printer 1530 without transmitting the identifier to user computer system 1520. Thus, printer 1530 may be part of, or may be remote from, user computer system 1520. User account 1514 may be activated or loaded with a monetary value amount, or both, at the time printed presentation instrument 1542 is printed with detectable symbol 1542. Optionally, such activating, loading, or both, may occur prior to printing, or subsequent to printing. For example, in some embodiments, a user or customer will print printed presentation instrument 1540, and then submit a request to host computer system 1510 activate or load presentation instrument 1540. Such a request can be made via any of a variety of communication modalities, including telephone 1580, Internet 1570, facsimile, postal or courier service, and the like. Often, such a request will be accompanied by a payment or promise of payment from the customer or user. Host computer system 1510 can then associate an activated status or value amount with the unique identifier, which corresponds to detectable symbol 1542 which is printed on presentation instrument 1540. Activation may be effected by any of a variety of entities, including a customer, a card issuer, a retailer, a distributor, a financial institution, a primary component manufacturer, or any entity or person or combination thereof associated with presentation instrument 1540. In some embodiments, one or more of these persons or entities may pre-load a presentation instrument with a currency amount or some other indication of value that can be exchanged or presented for a good or service. In some embodiments, printed presentation instrument 1540 is printed on paper, card stock, or the like. In related embodiments, printed presentation instrument 1540 may be exchanged for a replacement instrument 1550 comprising plastic or some other durable material. Replacement instrument 1550 may be provided by, for example, a retailer or other commercial outlet or vendor. Replacement instrument 1550 may include a magnetic stripe having a code that corresponds to unique identifier 1512. Replacement instrument 1550 can then be processed in activation, loading, settlement transactions and the like, in lieu of printed presentation instrument 1540.

Typically when printed presentation instrument 1540 is proffered to a merchant in a transaction, the instrument is swiped or otherwise presented to an instrument reader 1560. In some cases, printed presentation instrument 1540 may be coupled with a holder as shown in FIGS. 13 and 14, and the reader may include a sensor configured to read detectable symbol 1542 which allows host computer system 1510 to recognize the unique identifier corresponding with the symbol. Printed presentation instrument 1540 may be used with any of the activation, loading, and transactional techniques discussed herein. For example, host computer system 1510 may be configured to store, track, or otherwise analyze activation or loading activity or presentation instrument usage.

Having described several embodiments, it will be recognized by those of skill in the art that various modifications, alternative constructions, and equivalents may be used without departing from the spirit of the invention. The present invention encompasses systems which can carry out the methods described herein, and similarly encompasses methods for which the systems described herein may be used. Additionally, a number of well known processes and elements have not been described in order to avoid unnecessarily obscuring the present invention. For example, those skilled in the art know how to arrange computing devices into a network and configure communication among them. Accordingly, the above description should not be taken as limiting the scope of the invention, which is defined in the following claims.

What is claimed is:

1. A method of providing a postcard presentation instrument for use in a transaction, comprising:
applying an information storage medium to a postcard to create a postcard presentation instrument;
delivering the postcard presentation instrument to a destination via a distribution system; and
settling a transaction involving the postcard presentation instrument.

2. The method of claim 1, wherein the postcard presentation instrument is matched with a primary component.

3. The method of claim 2, wherein the primary component comprises a member selected from the group consisting of a magazine, a circular, a book, a newspaper, a value pack mailer, a periodical, a newsletter, a journal, and a mass mailer.

4. The method of claim 1, wherein the postcard presentation instrument comprises a fold-over postcard presentation instrument.

5. The method of claim 1, wherein the postcard presentation instrument is placed between two pages of a magazine.

6. The method of claim 1, wherein the postcard presentation instrument is affixed with a page of a magazine.

7. The method of claim 1, wherein the postcard presentation instrument is inserted into a value pack mailer.

8. A method of providing a presentation instrument for use in a transaction, comprising:
matching the presentation instrument with a primary component;
delivering the matched presentation instrument and primary component to a destination via a distribution system; and
settling a transaction involving the presentation instrument.

9. The method of claim 8, wherein the primary component comprises a member selected from the group consisting of a postcard, a magazine, a circular, a book, a newspaper, a value pack mailer, a periodical, a newsletter, a journal, and a mass mailer.

10. The method of claim 8, wherein the primary component comprises a postcard, and the presentation instrument is attached with the postcard via a perforation.

11. The method of claim 10, wherein the postcard comprises a fold-over postcard.

12. The method of claim 8, wherein the primary component comprises a magazine, and the presentation instrument is placed between two pages of the magazine.

13. The method of claim 8, wherein the primary component comprises a magazine, and the presentation instrument is affixed with a page of the magazine.

14. The method of claim 8, wherein the primary component comprises a value pack mailer.

15. The method of claim 8, wherein the distribution system comprises a member selected from the group consisting of a public postal system, a private postal system, and a courier service.

16. The method of claim 8, wherein the destination comprises a member selected from the group consisting of a newsstand location, a retail outlet location, a transportation system location, a sidewalk location, a post office box, a residential mailbox, a personal residence address, and a business address.

17. The method of claim 8, wherein the presentation instrument comprises a paper card stock material.

18. A system for providing a postcard presentation instrument for use in a transaction, comprising:
a processing system for applying an information storage medium to a postcard to create a postcard presentation instrument; and
a host computer system that receives a request to activate the postcard presentation instrument.

19. The system of claim 18, further comprising a distribution system that delivers the postcard presentation instrument from the processing system to a destination.

20. The system of claim 18, further comprising a settlement means that settles a transaction involving the postcard presentation instrument.

21. A presentation instrument assembly, comprising:
a primary component; and
a postcard presentation instrument removably matched with the primary component, the postcard presentation instrument having an information storage medium;
wherein the primary component comprises a magazine or a book.

22. A method for providing a presentation instrument for use in a transaction, comprising:
associating a unique identifier with a user account;
transmitting the unique identifier to a user computer via an electronic communication means, wherein the unique identifier is suitable for printing as a detectable symbol onto a presentation instrument;
reading the symbol to recognize the unique identifier;
settling a transaction involving the presentation instrument based on the unique identifier.
